(19) United States
(12) Patent Application Publication
(10) Pub. No.: US 2003/0049080 A1
(43) Pub. Date: Mar. 13, 2003

(54) Cut-off tool having improved cutting characteristics

(76) Inventor: Michael C. Clark, Columbiaville, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/241,295

(22) Filed: Sep. 10, 2002

Related U.S. Application Data
(60) Provisional application No. 60/318,761, filed on Sep. 12, 2001.

(51) Int. Cl. B26D 1/12; B26D 7/06; B27B 5/02

(52) U.S. Cl. 407/30; 83/156; 83/706

(57) ABSTRACT

A cut-off tool for cutting material includes a cutter body, an upper cutting roller and a lower cutting roller The rollers are coupled to the cutter body and form a channel for the material to pass through as the material is being cut. Each roller includes a roller body centered on an axis and having a front end and a back end and a cutting edge disposed between the front end and the back end. The cutting edge includes first and second tapered portions and a flat portion disposed between the first and second tapered portions. The first tapered portion extends from the back end and the second tapered portion extends from the front end.

This application claims priority to U.S. Provisional Application Serial No. 60/318,761, filed on Sep. 12, 2001.

### FIELD OF THE INVENTION

The present invention relates generally to cut-off tools and more particularly to a roller for a cut-off tool having a cutting edge with tapered portions.

### BACKGROUND OF THE INVENTION

Various cut-off tools are known in the art for cutting a material. These cutoff tools include a cutter body, an upper cutting roller rotatably connected to the cutter body, and a lower cutting roller rotatably connected to the cutter body. One of the cutting rollers is positioned on the inside of the cutter body and the other is positioned on the outside of the cutter body. Each of the upper and lower cutting rollers has a cutting edge in cooperation with each other to cut the material. The cutting edge of these cut-off tools is tapered for cutting the material.

However, these cut-off tools require the material to be scored or sawed prior to being cut to ensure an accurate cut of the material. Additionally, these cut-off tools are unable to accommodate materials that have areas of various thicknesses, such as nailing hems on siding material. Accordingly, it would be advantageous to provide a cut-off tool capable of overcoming these deficiencies.

### SUMMARY OF THE INVENTION

A cut-off tool having improved cutting characteristics capable of cutting a material with reduced force is described. The cut-off tool includes a cutting roller having a cutting edge. The cutting edge has a tapered portion and a flat portion having a predetermined width, wherein the flat portion enables the cut-off tool to cut certain selected materials with reduced force.

The cut-off tool of the subject invention allows the cutting of the material without having to score or saw the material and produces a clean cut on the material. Additionally, the cut-off tool allows the cutting of materials having areas of varying thickness and multiple layers, such as the nailing hem areas of siding material. The cut-off tool provides a clean cut edge of the material without any stress marks and jagged edges.

In one aspect of the present invention, a cutting roller for use in a cutting tool is provided. The roller includes a roller body centered on a first axis and having a front end and a back end and a cutting edge disposed between the front end and the back end. The cutting edge has first and second tapered portions and a flat portion disposed between the first and second tapered portions. The first tapered portion extends from the back end and the second tapered portion extends from the front end.

In another aspect of the present invention, a cut-off tool for cutting material having a cutter body, an upper cutting roller and a lower cutting roller is provided. The rollers are coupled to the cutter body and form a channel for the material to pass through as the material is being cut. Each roller includes a roller body centered on an axis and having a front end and a back end and a cutting edge disposed between the front end and the back end. The cutting edge includes first and second tapered portions and a flat portion disposed between the first and second tapered portions. The first tapered portion extends from the back end and the second tapered portion extends from the front end.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a side view of a portable sheet bending brake with a cut-off tool, according to an embodiment of the present invention;

FIG. 2 is a side view of a cutting roller of the subject invention;

FIG. 3A is an exploded view of section 3A in FIG. 2;

FIG. 3B is an exploded view of section 3B in FIG. 3A;

FIG. 4 is a perspective view of the cutting roller;

FIG. 5 is a perspective view of a cutter having an upper cutting roller cooperating with a lower cutting roller;

FIG. 6 is a perspective view of a cutter body having the upper cutting roller and the lower cutting roller attached thereto;

FIG. 7 is an additional perspective view of FIG. 6; and

FIG. 8 is a perspective view of the cutter body.

### DETAILED DESCRIPTION

Referring to the Figures, wherein like numerals indicate like or corresponding parts throughout the several views, a cut-off tool having improved cutting characteristics capable of cutting a material with reduced force is shown generally at 10.

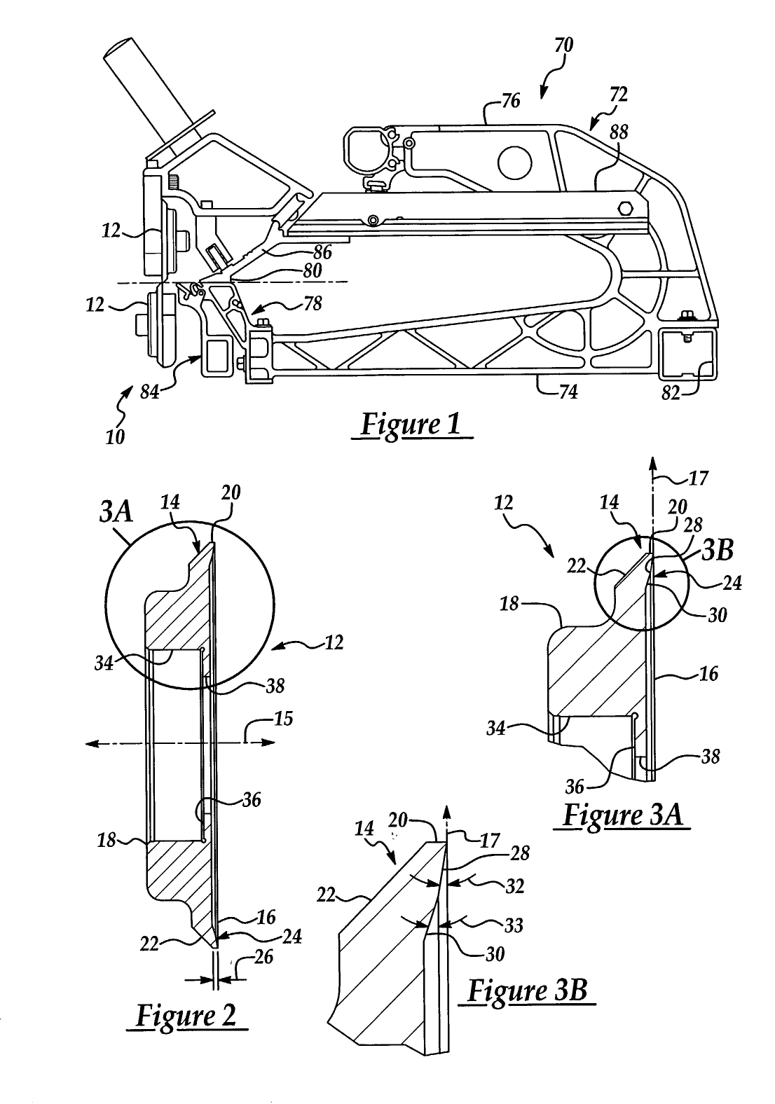

With particular reference to FIG. 1 in one embodiment, the cut-off tool 10 may be coupled to a sheet bending brake 70. The sheet bending brake 70 includes a pair of longitudinally spaced C-shaped frame members 72. Each frame member 72 includes a lower arm 74 and an upper arm 76 which overlies the lower arm 74 in spaced relation thereto. Legs may be provided as needed to support the brake 70 above the floor or working area.

A first extruded fixed member 78 is fixed on the ends of the lower arms 74 and defines a clamping surface 80. Longitudinally spaced base rails 82 are fixed to the rear end of the lower arms 74. A second extruded bending member 84 is hinged to the first member 78, as presently described, to provide a means for bending the sheet material.

Clamping member 86 extends longitudinally in overlying relationship to the clamping surface 80 of the first member 78. Means are provided for moving the anvil member toward and away from the clamping surface to clamp a workpiece on the clamping surface. The means for clamping the workpiece may comprise any suitable structure, but as herein shown comprise channel shaped pivot bars 88 pivoted on each frame member 72 with the clamping member 86 fixed thereto.

In use, a workpiece of sheet material is clamped against the clamping surface 78 and the bending member 84 is moved by swinging a handle 90 bringing the contacting portion of the bending member 84 in engagement with the sheet material.

In the illustrated embodiment, the cut-off tool 10 is shown and described as being coupled to the portable sheet bending brake 70, however, the present invention is not limited to such. Operation of the portable sheet bending brake is disclosed in U.S. Pat. No. 5,582,503 issued Dec. 10, 1996, which is hereby incorporated by reference.

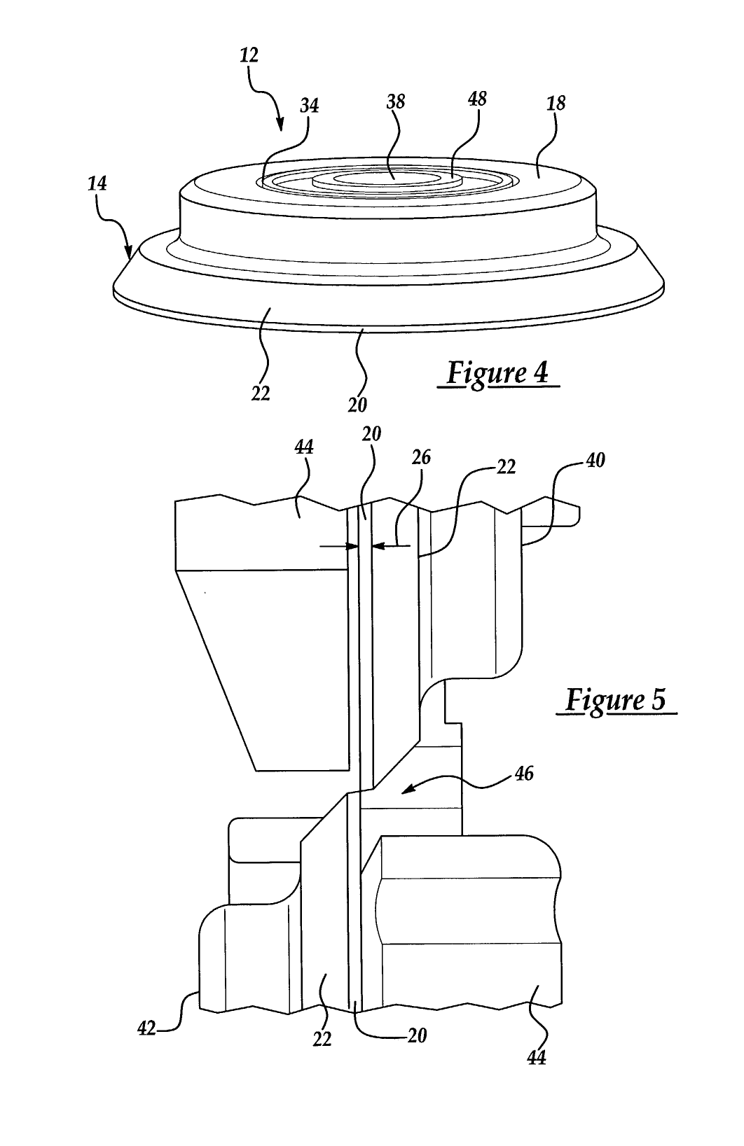

The cut-off tool 10 includes a pair of cutting rollers 12, each having a cutting edge 14, as shown in FIGS. 2-4. Each cutting roller 12 includes a roller body 13 and a front 16 and a back 18. The roller body 13 centered on a first axis 15. The cutting edge 14 extends between the front 16 and the back 18 of the cutting roller 12. The cutting edge 14 has a flat portion 20, a first tapered portion 22, and a second tapered portion 24. The flat portion 20 has a predetermined width 26, wherein the flat portion 20 enables the cut-off tool 10 to cut material with reduced force. The predetermined width 26 may be any desired width that achieves the results of the subject invention. In one embodiment, the width 26 is 0.020 inches wide. The flat portion 20 is horizontal relative to the face of the cutting roller 12. It is to be understood that the flat portion 20 may be angled differently than the first tapered portion 22 and the second tapered portion 24 to achieve the results of the subject invention. The first tapered portion 22 extends from the back 18 of the cutting roller 12 and intersects the flat portion 20. The second tapered portion 24 extends from the flat portion 20 and intersects the face of the cutting roller 12. The second tapered portion 24 may include a first section 28 and a second section 30. The first section 28 may have a taper angle 32 (relative to a second axis 17) different than the second section 30. For example, in FIG. 3B, the first section 28 has a taper angle 32 of 0.5° and the second section 30 has a taper angle 33 of 5.0°. In one embodiment, the second axis 17 is perpendicular to the first axis 15.

The back 18 of the cutting roller 12 includes a recess 34, an integral flange 36, and an aperture 38. The cutting roller 12 is utilized as an upper cutting roller 40 and a lower cutting roller 42, wherein the upper cutting roller 40 and the lower cutting roller 42 are identical to the cutting roller 12 as described above. The upper cutting roller 40 and the lower cutting roller 42 are connected to a cutter body 44 for forming the cut-off tool 10, as shown in FIGS. 5-8. The cutting rollers 40, 42 are connected to the cutter body 44 such that the back 18 of the cutting rollers 40, 42 is exposed. The upper cutting roller 40 is positioned on the outside of the cutter body 44 and the lower cutting roller 42 is positioned on the inside of the cutter body 44. The position of the cutting rollers 40, 42 form a channel 46 for the material to pass through as the material is being cut.

A roller bearing 48 extends into the recess 34 of each of the upper and lower cutting rollers 40, 42 and engages the integral flange 36 of the cutting rollers 40, 42. A spacer (not shown) is interposed between the cutter body 44 and the face of the cutting rollers 40, 42 and abuts the bearing 48. A bolt 52 extends through the aperture 38 of the cutting rollers 40, 42 and the bearing 48 and is threaded into the cutter body 44. The bolt 52 secures the cutting rollers 40, 42 to the cutter body 44. The cut-off tool 10 can be used on saw tables and sheet bending brakes as shown in U.S. Pat. Nos. 5,582,053 and 5,706,693, which are hereby incorporated by reference. The cut-off tool 10 also includes wheels 54, shown in FIG. 7, for engaging the tables and sheet bending brakes for moving the cut-off tool 10 along the material.

FIG. 5 shows the upper cutting roller 40 cooperating with the lower cutting roller 42 and forming the channel 46 for the material to pass through. Additionally, the flat portion 20 and the first tapered portion 22 of each of the cutting rollers 40, 42 are shown cooperating together.

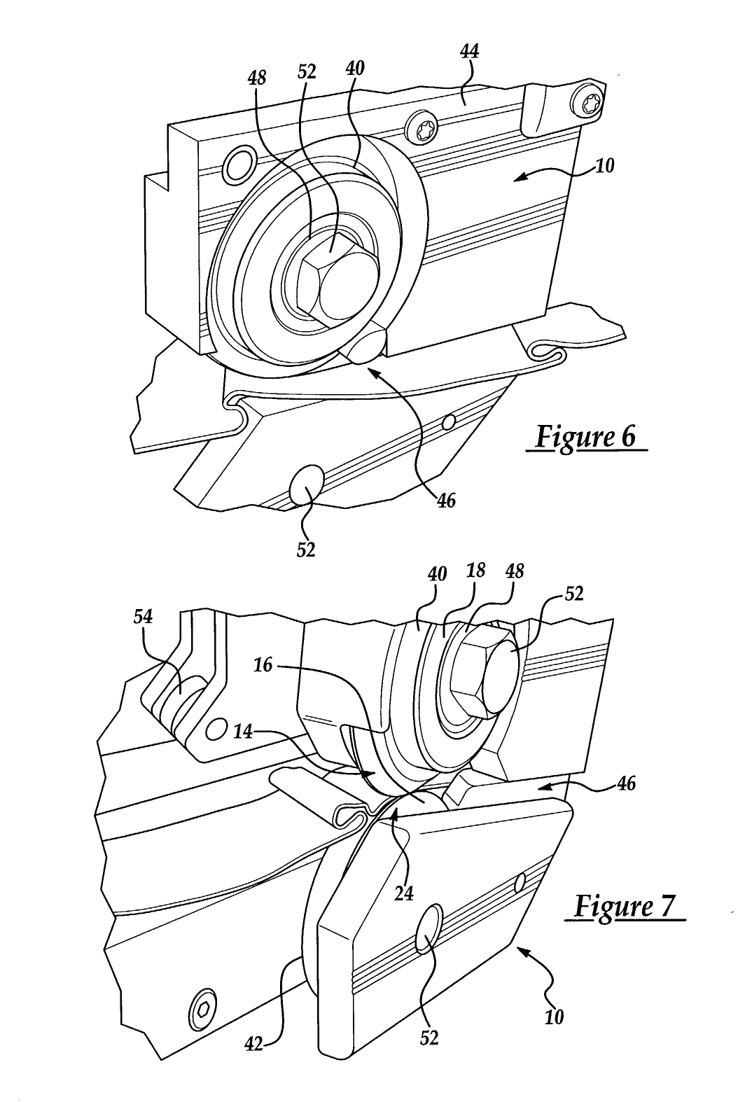

FIG. 6 shows the cut-off tool 10 being attached to the table and cutting a material having an area of varying thickness and multiple layers. The bolt 52 and the bearing 48 are also shown rotatably securing the upper cutting roller 40 to the cutter body 44.

FIG. 7 shows the cutter body 44 having the wheel 54 engaging the table for moving the cut-off tool along the material and shows the cooperating of the upper and the lower cutting rollers 40, 42 after having cut the material.

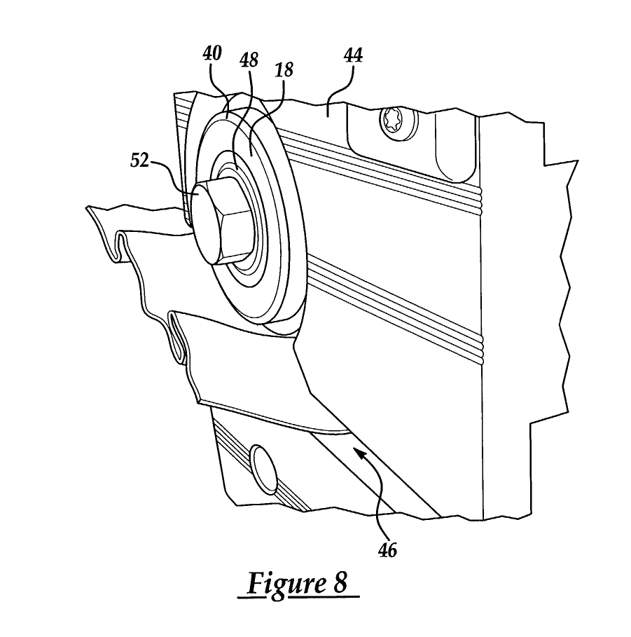

FIG. 8 shows the cut-off tool 10 being used to cut through a nailing hem area on a piece of siding material. The flat portion 20 of the cutting rollers 40, 42 allows the cutter to cut through varying thickness and multiple layers of materials.

The invention has been described in an illustrative manner, and it is to be understood that the terminology which has been used is intended to be in the nature of words of description rather than of limitation. Obviously, many modifications and variations of the present invention are possible in light of the above teachings. The invention may be practiced otherwise than as specifically described within the scope of the appended claims.

What is claimed is:

1. A cutting roller for use in a cutting tool, comprising:
a roller body centered on a first axis and having a front end and a back end; and,
a cutting edge disposed between the front end and the back end, the cutting edge having first and second tapered portions and a flat portion disposed between the first and second tapered portions, the first tapered portion extending from the back end and the second tapered portion extending from the front end.

2. A cutting roller, as set forth in claim 1, wherein the flat portion has a predetermined width.

3. A cutting roller, as set forth in claim 1, wherein the flat portion has a width of 0.020 inches.

4. A cutting roller, as set forth in claim 1, wherein the flat portion is parallel with the first axis.

5. A cutting roller, as set forth in claim 1, wherein the flat portion has an associated angle relative to the first axis.

6. A cutting roller, as set forth in claim 1, wherein the first tapered portion has a first section and a second section.

7. A cutting roller, as set forth in claim 6, wherein the first section has a first angle relative to a second axis and the second section had a second angle relative to the second axis.

8. A cutting roller, as set forth in claim 7, wherein the first angle is 0.5 degrees and the second angle is 5.0 degrees.

9. A cutting roller, as set forth in claim 6, wherein the second axis is perpendicular to the first axis.

10. A cutting roller, as set forth in claim 1, further comprising a recess in the center of the roller body.

11. A cutting roller, as set forth in claim 10, further comprising a flange formed along an end of the end, the flange forming an aperture.

12. A cut-off tool for cutting material, comprising:
a cutter body;
an upper cutting roller coupled to the cutter body; and,
a lower cutting roller coupled to the cutter body, the upper and lower cutting rollers forming a channel for the material to pass through as the material is being cut, each roller including:
a roller body centered on an axis and having a front end and a back end; and,
a cutting edge disposed between the front end and the back end, the cutting edge having first and second tapered portions and a flat portion disposed between the first and second tapered portions, the first tapered portion extending from the back end and the second tapered portion extending from the front end.

13. A cut-off tool, as set forth in claim 12, wherein the flat portion has a predetermined width.

14. A cut-off tool, as set forth in claim 12, wherein the flat portion has a width of 0.020 inches.

15. A cut-off tool, as set forth in claim 12, wherein the flat portion of each roller is parallel with the axis.

16. A cut-off tool, as set forth in claim 12, wherein the flat portion has an associated angle relative to the axis.

17. A cut-off tool, as set forth in claim 12, wherein the first tapered portion has a first section and a second section.

18. A cut-off tool, as set forth in claim 17, wherein the first section has a first angle relative to a second axis and the second section had a second angle relative to the second axis.

19. A cut-off tool, as set forth in claim 18, wherein the first angle is 0.5 degrees and the second angle is 5.0 degrees.

20. A cut-off tool, as set forth in claim 16, wherein the second axis is perpendicular to the first axis.

21. A cut-off tool, as set forth in claim 12, further comprising a recess in the center of the body of each above along the first axis.

22. A cutting roller, as set forth in claim 10, further comprising a flange formed along an end of the end, the flange forming an aperture.
